(19) United States
(12) Patent Application Publication
(10) Pub. No.: US 2012/0103021 A1
(43) Pub. Date: May 3, 2012

(54) APPARATUS AND METHOD FOR REDUCING GASEOUS INCLUSIONS IN A GLASS

(76) Inventors: Keisha Chantelle Ann Antoine, Painted Post, NY (US); Megan Aurora DeLamielleure, Corning, NY (US); Irene Mona Peterson, Elmira Heights, NY (US)

(21) Appl. No.: 13/282,790

(22) Filed: Oct. 27, 2011

Related U.S. Application Data
(62) Division of application No. 12/368,585, filed on Feb. 10, 2009, now abandoned.
Application No. 12/368,585 is a continuation-in-part of application No. 12/269,310, now abandoned.

(51) Int. Cl. C03B 5/225; C03B 5/235; C03B 5/23

(52) U.S. Cl. 65/134.9

(57) ABSTRACT

A method for reducing gaseous inclusions in high melting temperature or high strain point glasses is described. The method includes heating a batch material within a melting vessel to form molten glass at a melting temperature T_{M}, the molten glass comprising a multivalent oxide material; heating the molten glass within a fining vessel to a fining temperature T_{F}≧T_{M}; and cooling the molten glass within a refractory tube after the first or second heating step to a cooling temperature T_{C} less than T_{M}. The molten glass remains within the refractory tube for a time sufficient to reduce a volume of gaseous inclusions in the molten glass and cause gas species to migrate out of the gaseous inclusions into the molten glass such that at least a portion of the gaseous inclusions collapse into the molten glass.

### CROSS-REFERENCE TO RELATED APPLICATION

This application is a Divisional and claims the benefit of priority under 35 U.S.C. §120 to continuation-in-part U.S. patent application Ser. No. 12/368,585 filed on Feb. 10, 2009 and U.S. patent application Ser. No. 12/269,310, filed on Nov. 12, 2008, the contents of which are relied upon and incorporated herein by reference in its entirety.

### TECHNICAL FIELD

The present invention relates to a glass manufacturing system and a method for reducing gaseous inclusions in a glass. In one embodiment, the glass manufacturing system and method are particularly useful for reducing gaseous inclusions in high melting temperature or high strain point glasses, such as those that are used as glass substrates in flat panel display devices.

### BACKGROUND

Flat display devices such as liquid crystal displays (LCDs) are made from flat glass substrates or sheets. Conventional glass manufacturing processes for LCD glass typically begin by melting glass precursors—feed materials—in a melting furnace. Reactions which occur during this melting stage release gases which form bubbles in the glass melt. Seeds may also be generated by interstitial air trapped between particles of the feed materials. In any event, these gas bubbles and seeds (collectively referred to herein as gaseous inclusions) must be removed to produce high quality glass. The removal of gaseous inclusions is generally accomplished by “fining” the glass melt. For clarity, gaseous inclusions formed as a result of the melting process, whether as reaction products or interstitial gases, may also be referred to hereinafter as “seeds”, “blisters”, or “bubbles”.

A common method of fining a glass melt is by chemical fining. In chemical fining, a fining agent is introduced into the glass melt, such as by addition to the feed material. The fining agent is a multivalent oxide material that is reduced (loses oxygen) at high temperatures, and is oxidized (recombines with oxygen) at low temperatures. Oxygen released by the fining agent may then diffuse into the seeds formed during the melting process causing seed growth. The buoyancy of the seeds is thereby increased, and they rise to the surface of the glass where the gas is released out of the melt. Ideally, it is desirable that the fining agent releases oxygen late in the melting process, after most of the seeds have formed, thereby increasing the effectiveness of the fining agent. To that end, although large seeds may be eliminated in the melting vessel, the glass typically undergoes additional fining in a fining vessel, where the temperature of the glass melt is typically increased above the melting temperature. The increase in temperature of the glass melt within the fining vessel reduces the viscosity of the glass, making it easier for seeds in the glass melt to rise to the surface of the glass, and a multivalent oxide fining agent will release a fining gas (oxygen) to the glass melt to cause seed growth and assist with the seed removal process. Once the glass melt has been fined, it may be cooled and stirred, and thereafter formed, such as into a glass sheet, through any one of a variety of available forming methods known in the art.

Many conventional glass manufacturing processes employ arsenic as a fining agent. Arsenic is among the highest temperature fining agents known, and, when added to the molten glass bath in the melting furnace (melting vessel), it allows for O₂ release from the glass melt at high temperatures (e.g., above 1450° C.). This high temperature O₂ release, which aids in the removal of seeds during the melting stage and in particular during the fining stage of glass production results in a glass product essentially free of gaseous inclusions.

From an environmental point of view, it would be desirable to provide alternative methods of making glass, and particularly the high melting point and strain point glasses typically employed in the manufacture of LCD glass, without having to employ arsenic as a fining agent. Arsenic-containing compounds are generally toxic, and processing of glass with arsenic results not only in manufacturing wastes that are expensive to process, but also creates disposal issues relative to the display device itself after the useful life of the device. Unfortunately, many alternative fining agents typically release less oxygen, and/or at too low a temperature, and reabsorb too little O₂ during the conditioning process relative to established fining agents such as arsenic, thereby limiting their fining and oxygen re-absorption capabilities. Thus, during the fining stage of the glass production process (i.e. while the glass is within the fining vessel), the fining agent may produce an insufficient quantity of oxygen to effectively fine the glass within the fining vessel. It would therefore be beneficial to find a way that can be used to reduce gaseous inclusions in a glass without the need for the use of toxic fining agents.

### SUMMARY

In one aspect, the present invention provides a method for reducing gaseous inclusions in a glass, the method including the steps of: (a) heating a batch material within a melting vessel to form molten glass at a melting temperature T_{M}, the molten glass comprising a multivalent oxide material; (b) cooling the molten glass within a refractory tube to a cooling temperature T_{C} which is less than T_{M}, where the molten glass remains within the refractory tube for a predetermined resident time; and (c) heating the cooled molten glass within a fining vessel to a fining temperature T_{F}≧T_{M}.

In yet another aspect of the present invention there is provided a glass manufacturing system including: (a) a melting vessel that melts batch materials and forms molten glass at a melting temperature T_{M}, where the molten glass comprises a multivalent oxide material; (b) a refractory tube, coupled to the melting vessel, that receives the molten glass and cools the molten glass to a cooling temperature T_{C} which is less than T_{M}, where the molten glass remains within the refractory tube for a predetermined resident time to reduce a volume of the gaseous inclusions in the molten glass and cause gas species to migrate out of the gaseous inclusions into the molten glass such that at least a portion of the gaseous inclusions collapse into the molten glass; and (c) a fining vessel, coupled to the refractory tube, that heats the cooled molten glass to a fining temperature T_{F}≧T_{M}.

In still yet another aspect of the present invention there is provided a method for reducing gaseous inclusions in a glass, the method including the steps of: (a) heating a batch material within a melting vessel to form molten glass at a melting temperature T_{M}, the molten glass comprising a multivalent oxide material; (b) heating the molten glass within a fining vessel to a fining temperature T_{F}≧T_{M}; and (c) cooling the molten glass within a refractory tube from T_{F} to a cooling temperature T_{C}<T_{M}, where T_{C} is in a range between about 1500° C. and 1630° C., where the molten glass remains within the refractory tube for a predetermined resident time of at least about 1 hour.

In yet another aspect of the present invention there is provided a glass manufacturing system including: (a) a melting vessel that melts batch materials and forms molten glass at a melting temperature T_{M}, where the molten glass comprises a multivalent oxide material; (b) a first refractory tube, coupled to the melting vessel, through which passes the molten glass; (c) a fining vessel, coupled to the first tube, that heats the cooled molten glass to a fining temperature T_{F}≧T_{M}; and (d) a second refractory tube, coupled to the fining vessel, that receives the molten glass and cools the molten glass to a cooling temperature T_{C}<T_{M}, where T_{C} is in a range between about 1500° C. and 1630° C. and the cooled molten glass remains within the second refractory tube for a predetermined resident time of at least about 1 hour to reduce a volume of the gaseous inclusions in the molten glass and cause gas species to migrate out of the gaseous inclusions into the molten glass such that at least a portion of the gaseous inclusions collapse into the molten glass.

Additional aspects of the invention will be set forth, in part, in the detailed description, figures and any claims which follow, and in part will be derived from the detailed description, or can be learned by practice of the invention. It is to be understood that both the foregoing general description and the following detailed description are exemplary and explanatory only and are not restrictive of the invention as disclosed.

### BRIEF DESCRIPTION OF THE DRAWINGS

A more complete understanding of the present invention may be had by reference to the following detailed description when taken in conjunction with the accompanying drawings wherein:

FIG. 1 is a side view of an exemplary glass manufacturing system in accordance with an embodiment of the present invention;

FIG. 2 is a flowchart illustrating the basic steps of a method for reducing gaseous inclusions in a glass in accordance with an embodiment of the present invention;

FIGS. 3A-3D illustrate various photos and graphs which are the results of experiments conducted to test the method shown in FIG. 2 in accordance with an embodiment of the present invention;

FIG. 4 is a side view of an exemplary glass manufacturing system in accordance with another embodiment of the present invention;

FIG. 5 is a graph that shows calculated data which indicates the time it takes a single bubble with a specific diameter to collapse when subjected to a variety of different temperatures; and

FIG. 6 is a flowchart illustrating the basic steps of a method for reducing gaseous inclusions in a glass in accordance with another embodiment of the present invention.

### DETAILED DESCRIPTION

In the following description, a brief discussion about a typical glass making process is provided first and then a detailed discussion is provided to describe details and enable a thorough understanding about several exemplary embodiments of the glass manufacturing system and method used to reduce gaseous inclusions in a glass in accordance with the present invention. However, it will be apparent to one having ordinary skill in the art, having had the benefit of the present disclosure, that the present invention may be practiced in other embodiments that depart from the specific details disclosed herein. Moreover, it will be apparent to one having ordinary skill in the art that descriptions of well-known devices, methods and materials have been omitted so as not to obscure the description of the present invention.

In a typical glass making process raw feed materials are heated in a furnace (melter, melting vessel) to form a viscous mass (glass melt). Furnaces are generally constructed from refractory blocks comprised of burned flint clay, sillimanite, zircon or other refractory material. The feed materials may be introduced into the melter either by a batch process, where the glass forming constituents are mixed together and introduced into the melter as a discrete load, or the feed materials are mixed and introduced into the melter continuously. The feed materials may include scrap glass, commonly called “cullet”. The feed materials may be introduced into the melter through an opening or port in the furnace structure, either through the use of a push bar, in the case of a batch process, or a screw or auger apparatus in the case of a continuous feed melter. The amount and type of feed material constituents make up the glass “recipe”. Batch processes are typically used for small amounts of glass and used in furnaces having a capacity on the order of up to a few tons of glass, whereas a large commercial, continuous feed furnace may hold in excess of 1,500 tons of glass, and deliver several hundred tons of glass per day.

The feed materials may be heated in the melter by a fuel-oxygen flame issuing from one or more burners above the feed material, by an electric current passed between electrodes typically mounted in the interior melter walls, or both. A crown structure above the walls, also made from refractory block, covers the melter and, in a combustion-heated furnace, provides a space for combustion of the fuel. In some processes, the feed materials are first heated by a fuel-oxygen flame, whereupon the feed materials begin to melt and the resistivity of the feed materials begin to decrease. An electric current is thereafter passed through the feed materials/melt mixture to complete the heating process.

As the feed or batch materials are heated, reaction of the materials releases a variety of gases that form gaseous inclusions, commonly referred to as blisters, seeds or bubbles, within the glass melt. These bubbles may also form as a result of air trapped within the interstitial spaces between the particles of feed material, and from dissolution of the refractory blocks themselves into the melt. The gases may comprise, for example, any one or a mixture of O₂, CO₂, CO, N₂ and NO. Other gases may also be formed and comprise a seed. Water is a frequent by-product of the melting process.

During the initial stages of melting, a foamy mass is formed within the melter and typically is dispersed over the top of the melting and molten material. Unless gas bubbles are removed, they may be carried through the remainder of the glass forming operations, eventually becoming frozen into the final glass product and resulting in visible imperfections in the product. Foam at the top of the melt may be prevented from exiting the melter by skimming the melt with “floaters” or a bridge wall which are located within the melter. Large bubbles within the melt may rise to the surface of the melt, where the gases contained within those bubbles are thereby released from the molten glass. Convection currents arising from thermal gradients in the melt aid in homogenizing the molten glass. However, the residence time of the molten glass in the melter may be insufficient for smaller bubbles to be eliminated.

To ensure maximum bubble removal, glass manufacturers commonly employ a chemical fining process by including a fining agent among the feed materials. The fining agent generates additional gas (typically oxygen) into the molten glass. The fining gas dissolves into the molten glass and diffuses into the bubbles, spurring the growth and increasing the buoyancy of the bubbles.

As was described in the Background Section, arsenic typically in the form As₂O₅ has been used for years as a fining agent. As₂O₅ is believed to achieve bubble-free glass by reducing the arsenic from a valence state of +5 to a valence state of +3 at high temperature, after most of the melting is complete. This reduction releases oxygen into the molten glass that diffuses into the bubbles, causing the bubbles to grow and rise through and out of the molten glass. Arsenic has the additional advantage of assisting in the removal of any bubbles that may remain in the glass during the subsequent cooling, conditioning and forming phases of the glass by reabsorbing excess oxygen. As such, arsenic is an outstanding fining agent, producing glass virtually free of bubbles with very little intervention.

Unfortunately, arsenic is a toxic material. The processing of glass with arsenic results in wastes that are expensive to process and creates disposal issues relative to the finished glass after the useful life of the formed article. Accordingly, fining is performed today such that the finished glass is essentially free of As₂O₃, i.e., the finished glass has at most 0.05 mole percent As₂O₃. Most preferably, no As₂O₃ is purposely used in the fining of the glass. In such cases, the finished glass will still have at most 0.005 mole percent As₂O₃ as a result of contaminants present in the batch materials and/or the equipment used to melt the batch materials.

Antimony oxide (Sb₂O₅) may be utilized as a substitute for arsenic, but antimony is closely related to arsenic in terms of chemical behavior and therefore possesses many of the same challenges as arsenic, such as for waste disposal. In addition, Sb₂O₃ raises the density, raises the coefficient thermal expansion (CTE), and lowers the strain point of glasses in comparison to glasses which use As₂O₃ as a fining agent. Accordingly, fining is performed today such that the finished glass is essentially free of Sb₂O₃, i.e., the finished glass has at most 0.05 mole percent Sb₂O₃. Most preferably, no Sb₂O₃ is purposely used in the fining of the glass. In such cases, the finished glass will still have at most 0.005 mole percent Sb₂O₃ as a result of contaminants present in the batch materials and/or the equipment used to melt the batch materials.

Tin oxide (SnO₂) is another fining agent that has seen use in glass production. However, although tin oxide undergoes similar redox reactions as arsenic, the very low solubility limit of tin oxide at the forming temperature of glasses for display applications (approximately 1200° C.), limits how much can be added to the batch and consequently the amount of oxygen available for fining. Accordingly, the concentration of SnO₂ in the finished glass is typically less than or equal to about 0.15 mole percent. Tin fining can be used alone or in combination with other fining techniques if desired. For example, tin fining can be combined with halide fining, e.g., bromine fining. Other possible combinations include, but are not limited to, tin fining plus sulfate, sulfide, cerium oxide, Fe₂O₃ and halide containing compounds. Indeed, U.S. Pat. No. 6,468,933 describes a glass forming process that employs a mixture of SnO₂ and a halide-containing compound in the form of a chloride (e.g., BaCl₂ or CaCl₂) as fining agents in a glass manufacturing system essentially free of arsenic and antimony. Also, these fining techniques, or other fining techniques, can be used by themselves (or in combinations) without the use of tin fining.

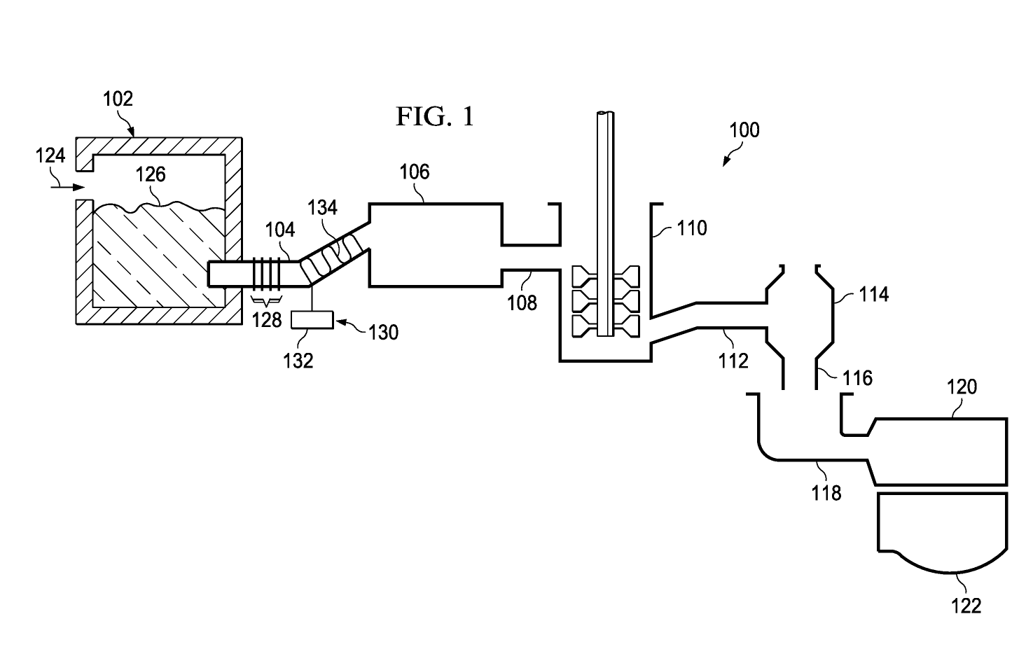

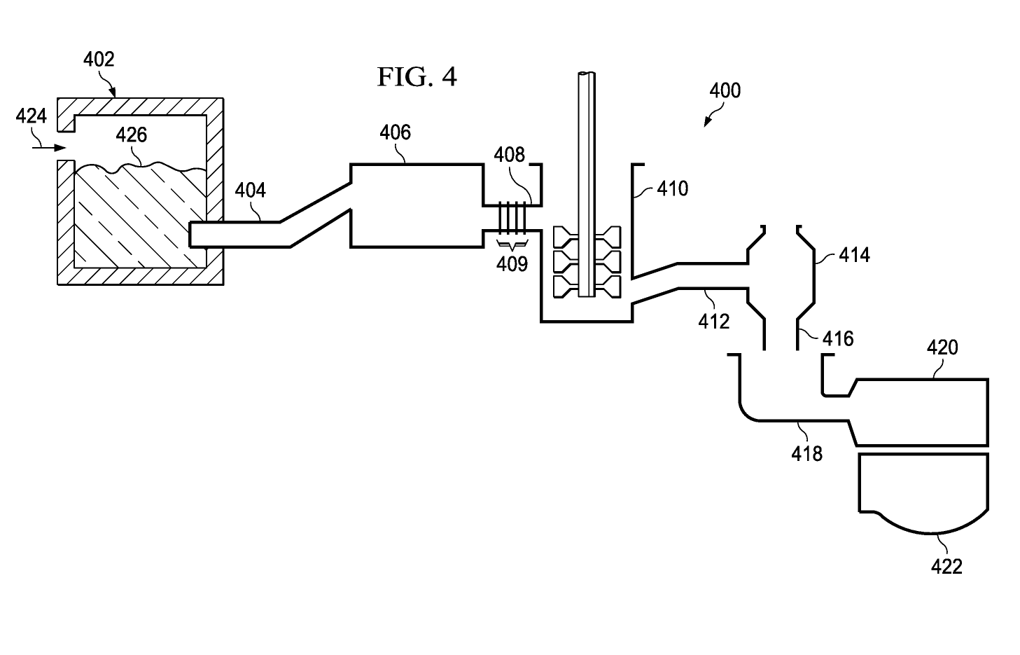

The inventors in solving the fining problem herein propose several exemplary embodiments of a glass manufacturing system and method for reducing gaseous inclusions in a glass without the need for the use of toxic fining agents like arsenic and antimony oxide. However, the exemplary glass manufacturing systems and methods described herein could if desired use those toxic fining agents. The method broadly includes the steps of: (a) heating a batch material within a melting vessel to form molten glass at a melting temperature T_{M}, the molten glass comprising a multivalent oxide material (e.g., fining agent); (b) heating the molten glass within a fining vessel to a fining temperature T_{F}≧T_{M}; and (c) cooling the molten glass within a cooling refractory tube after the first heating step or after the second heating step to a cooling temperature T_{C} less than T_{M}, where the molten glass remains within the cooling refractory tube for a predetermined resident time to reduce a volume of the gaseous inclusions in the molten glass and cause gas species to migrate out of the gaseous inclusions into the molten glass such that at least a portion of the gaseous inclusions collapse into the molten glass. The method includes two embodiments where in the first embodiment the cooling refractory tube is positioned between the melting vessel and the fining vessel as will be discussed below with respect to FIGS. 1-3. The second embodiment of the method is where the cooling refractory tube is positioned on an output of the fining vessel as will be discussed below with respect to FIGS. 4-6.

Referring to FIG. 1, there is shown a schematic view of an exemplary glass manufacturing system 100 in accordance with an embodiment of the present invention that uses a fusion process to make a glass sheet 122. The fusion process is described, for example, in U.S. Pat. Nos. 3,338,696 and 3,682,609, the contents of which are incorporated herein by reference. The exemplary glass manufacturing system 100 includes a melting vessel 102 (e.g., melter 102, melting furnace 102), a new cooling refractory tube 104 (cooling refractory vessel 104), a fining vessel 106, a finer to stir chamber connecting tube 108, a mixing vessel 110 (e.g., stir chamber 110), a stir chamber to bowl connecting tube 112, a delivery vessel 114 (e.g. bowl 114), a downcomer 116, an inlet 118, and a forming vessel 120 (e.g. fusion pipe 120) which is used to form the glass sheet 122. Typically, the components 104, 106, 108, 110, 112, 114, 116 and 118 are made from platinum or platinum-containing metals such as platinum-rhodium, platinum-iridium and combinations thereof, but they may also comprise other refractory metals such as molybdenum, palladium, rhenium, tantalum, titanium, tungsten, or alloys thereof. The forming vessel 120 is typically made from a ceramic or glass-ceramic refractory material.

Glass raw materials are fed as shown by arrow 124 into the melting furnace 102 in accordance with a recipe specific to the desired glass composition. The raw feed materials may be fed in a batch mode or via a continuous method, and may include, but are not limited to, oxides of Si, Al, B, Mg, Ca, Zn, Sr, or Ba. Feed materials may also be cullet from previous melting operations. A non-toxic multivalent fining agent, such as SnO₂, may be included in the initial feed materials, or may be subsequently added to the molten glass 126. Alternatively, in the case of SnO₂, it may not be necessary to add the SnO₂ to the feed materials, as the electrode material in a melting furnace which incorporates electrically heated melting is often comprised of SnO₂. Thus, sufficient SnO₂ may be added to the molten glass 126 through the gradual disintegration of the electrodes. The feed materials may be heated by anyone of a variety of glass-making methods. For example, the feed materials may be initially heated by way of combustion burners located over the surface of the feed materials. Once a suitable temperature has been attained through the use of combustion burners such that the resistivity of the molten glass 126 is sufficiently lowered, an electric current may thereafter be passed through the body of the molten glass 126 by the electrodes to heat the molten glass 126 from within. In any case, the raw feed materials are heated within melting furnace 102 and melted to form the molten glass 126 at a melting temperature T_{M} (e.g., 1500° C.-1650° C.). The melting temperature T_{M} may vary depending upon the specific glass composition. For display glasses, and in particular hard glasses (i.e. glass having a high melting temperature), melting temperatures may be in excess of 1500° C., more preferably greater than about 1550° C.; and for some glasses at least about 1650° C.

In accordance with the present embodiment, once the melting vessel 102 has melted the raw feed materials to form the molten glass 126 at melting temperature T_{M}, the molten glass 126 flows into the cooling refractory tube 104. The cooling refractory tube 104 is configured to cool the molten glass 126 to a cooling temperature T_{C} which is less than the melting temperature T_{M} and to ensure that the molten glass 126 remains therein for a predetermined resident time which is about 10-30 minutes. In an embodiment, the cooling temperature T_{C} is about 10° C. less than the melting temperature T_{M} where T_{M} is in a range between about 1500° C. and 1650° C. Moreover, T_{M} can be in anyone of the following ranges: (a) about 1500° C.-1510° C.; (b) about 1510° C.-1520° C.; (c) about 1520° C.-1530° C.; (d) about 1530° C.-1540° C.; (e) about 1540° C.-1550° C.; (f) about 1550° C.-1560° C.; (g) about 1560° C.-1570° C.; (h) about 1570° C.-1580° C.; (i) about 1580° C.-1590° C.; (j) about 1590° C.-1600° C.; (j) about 1600° C.-1610° C.; (k) about 1610° C.-1620° C.; (l) about 1620° C.-1630° C.; (m) about 1630° C.-1640° C.; and (n) about 1640° C.-1650° C.

In an embodiment, the cooling refractory tube 104 has one or more cooling fins 128 (located near the melting vessel 102) and an optional heating mechanism 130 (located near the fining vessel 106). For instance, the heating mechanism 130 can include a power source 132 (e.g., battery 132) connected to a wire 134 which is wrapped around a portion of the exterior surface of the refractory tube 104 and the current within the wire 134 heats the refractory tube 104. The cooling refractory tube 104 may or may not have a free surface area for the molten glass 126. Plus, the cooling refractory tube 104 may if desired have a portion thereof which is located below both the melting vessel 102 and the fining vessel 106. If the cooling refractory tube 104 has a portion located below the melting vessel 102 and the fining vessel 106 this can be beneficial because the added head pressure from the molten glass 126 above the cooling refractory tube 104 can assist in shrinkage of the blisters in the molten glass 126 by increasing the amount of pressure inside the blisters, according to the ideal gas law PV=nRT.

The cooling refractory tube 104 by cooling the molten glass 126 eliminates at least a portion of the gaseous inclusions (seeds, bubbles, blisters) which collapse into the molten glass 126. Without wishing to be held to any particular theory, it is believed that when molten glass 126 with bubbles in it is lowered in temperature, the bubble size shrinks due to two mechanisms. The first mechanism is based on temperature where according to the Ideal Gas Law:

PV=nRT (1)

where,
P=pressure (Pa)
V=volume (m³)
n=amount of gas (mols)
R=ideal gas constant, 8.314472 m³·Pa·K⁻¹·mol⁻¹
T=temperature (K)

In accordance with the Ideal Gas Law, when the temperature is reduced and all other factors are constant, the volume of each bubble within the molten glass 126 must reduce in direct proportion. In particular, since V=4/3πr³ for a sphere, the bubble radius is decreased by the cube root,

$$r = {[ \frac{4 V}{3 π} ]}^{\frac{1}{3}} .$$

Additionally, when the temperature of the molten glass 126 is reduced then the solubility of many gasses increases. These include the typical gases that are found in the bubbles located within the molten glass 126, including but not limited to O₂, CO₂, and SO₂. As the glass melt solubility for gas species in a bubble increases, then the gas species migrate out of the bubble and into the molten glass 126, reducing the amount of gas in the bubble, or n. If all other factors are constant, then the volume of the bubble will decrease directly proportional to the reduction in n. In view of these two mechanisms, the reduction of the temperature and the gas content in the bubbles shrinks some of the smaller bubbles to a critical radius at which maintaining a surface is not energetically favorable. These bubbles will then collapse into the molten glass 126 and the new oxygen (fining gas) in the molten glass 126 then becomes available to replenish (recombine with) the fining agent which is useful during for the subsequent fining process. The cooling step takes time such that the smaller bubbles can collapse, hence the resident time of about 10-30 minutes in the cooling refractory tube 104. But, this resident time could be any amount of time (e.g., <10 minutes or >30 minutes) that allows sufficient oxygen to diffuse into the molten glass 126 which is dependent upon the temperature (and therefore viscosity) of the molten glass 126 and the time at which the molten glass 126 is maintained at the reduced cooling temperature T_{C}. Plus, the cooling refractory tube 104 has an optional heating mechanism 130 which may be used to increase the temperature of the molten glass 126 to or close to the fining temperature (e.g., 1640° C.) before the molten glass 126 enters the fining vessel 106.

In some embodiments, the molten glass 126 may be maintained within the cold hold temperature range by configuring the cooling refractory tube 104 (or cooling refractory vessel 104) to be sufficiently large to accommodate the volume of molten glass 126 expected to be received at a particular flow rate, and to account for the fluid exchange rate to ensure each discrete volume of molten glass 126 experiences the full hold time within the hold temperature range. Because the hold time may cause the molten glass 126 to cool below the hold temperature range, it is preferred that the cooling refractory tube 104 (be it the transport piping or a holding tank) which facilitates the low conditioning hold is heated. For example, the transport piping is typically a refractory metal, such as platinum or a platinum alloy (e.g. platinum-rhodium) that can be directly electrically heated by passing a current through the piping. Similarly, a hold vessel may be formed from a suitable metal and directly heated as above. The hold vessel may comprise separate electrodes (e.g. tin electrodes) and a current be passed through the molten glass 126 itself, or the hold vessel may be “fired” by an external source, such as one or more gas flames. Thus, the molten glass 126 may be heated during the hold time, but only so far is necessary to maintain a temperature of the glass melt within the hold temperature range and then heat the molten glass 126 to get ready for the fining process.

Once, the molten glass 126 leaves the cooling refractory tube 104 it enters the fining vessel 106 and undergoes the fining process where the molten glass 126 is re-heated to a fining temperature T_{F} at least as high as the melting temperature T_{M} and preferably greater than the melting temperature T_{M}. Typically, the fining vessel 106 heats the molten glass 126 to a fining temperature T_{F} which is in a range between about 1630° C. and 1720° C. While the molten glass 126 is at the fining temperature T_{F}, the high temperature causes the fining agent to release oxygen (fining gas). The oxygen (fining gas) released by the fining agent then becomes available to cause the growth of the bubbles and the removal of all or at least most of the remaining bubbles in the molten glass 126. By using the cooling refractory tube 104 to cause the collapse of the small bubbles before the fining process means that the total number of bubbles which receive a finite amount of the fining gas during the fining process is reduced. This means that each remaining bubble may grow larger and thus rise faster than would have been possible without the previous small bubble removal in the cooling refractory tube 104. Additionally, since the smallest bubbles are the ones removed in the cooling refractory tube 104, the average bubble size, before the fining gas is added in the fining vessel 106, is larger than it would be otherwise. So, the bubbles in the molten glass 126 located in the fining vessel 106 will be larger for two reasons. First, the smallest bubbles have been removed. Second, the available fining gas is divided between fewer bubbles and therefore can increase the remaining bubbles to larger sizes. This is a marked improvement over the conventional process.

After the fining process, the molten glass 126 flows through the finer to stir chamber connecting tube 108 to the mixing vessel 110 (e.g., stir chamber 110) for homogenization. Then, the molten glass 126 flows through the stir chamber to bowl connecting tube 112 to the delivery vessel 114 (e.g. bowl 114). The delivery vessel 114 delivers the molten glass 126 through the downcomer 116 and the inlet 118 into the forming vessel 120 (e.g., isopipe 120, fusion pipe 120) to form the glass sheet 122 per the fusion glass making process.

In the fusion glass making process, the molten glass 126 is flowed to the forming vessel 120 (also known as a fusion pipe, isopipe, forming wedge) where the molten glass 126 overflows the upper edges of the forming vessel 120. The molten glass 126 then flows down along converging forming surfaces on the forming vessel 120 and the separate flows join along the apex of the converging forming surfaces to form a glass sheet 122. Accordingly, the molten glass 126 which has been in contact with the converging forming surfaces forms the interior of the glass sheet 122, and the surface of the glass sheet 122 remains pristine. As indicated earlier, a more detailed description of a fusion glass forming method and apparatus may be found in U.S. Pat. Nos. 3,338,696 and 3,682,609. A person skilled in the art should readily appreciate that any type of glass manufacturing system that employs a fining vessel 106/fining step to make a glass sheet can also incorporate and use the cooling refractory tube 104 in accordance with an embodiment of the present invention.

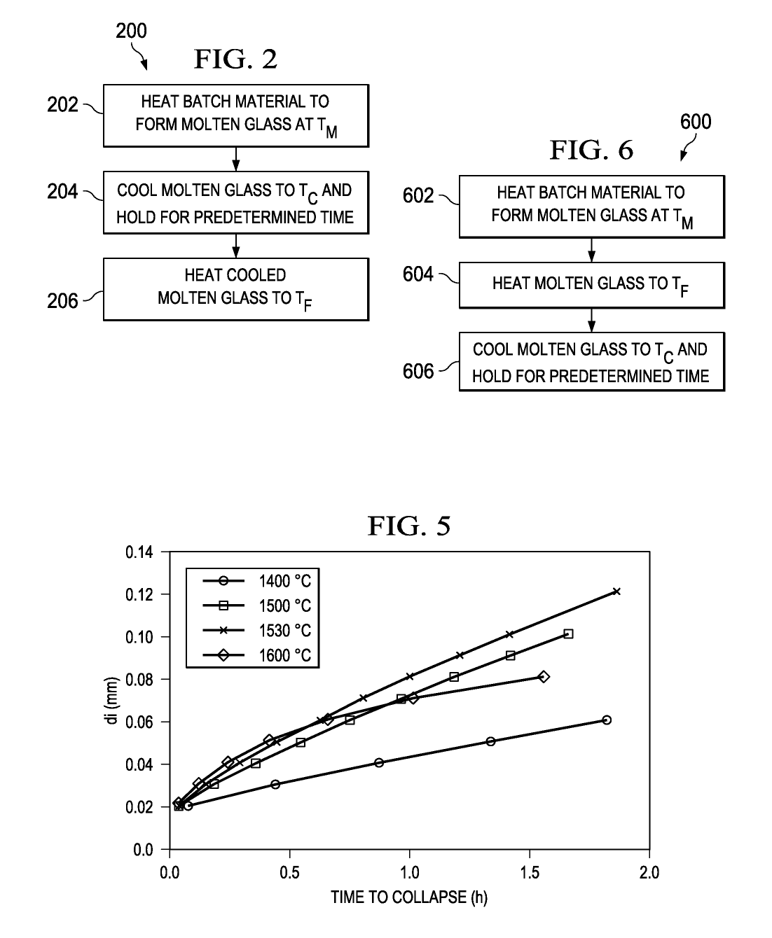

Referring to FIG. 2, there is a flowchart illustrating the basic steps of a method 200 for reducing gaseous inclusions in a glass in accordance with an embodiment of the present invention. Beginning at step 202, a batch material is heated within a melting vessel 102 to form molten glass 126 at a melting temperature T_{M}, where the molten glass 126 contains a multivalent oxide material (fining agent). In one embodiment, the melting temperature T_{M} is in a range between about 1500° and 1650° C. At step 204, the molten glass 126 is cooled within the cooling refractory tube 104 to a cooling temperature T_{C} and held for a predetermined resident time. In one embodiment, the molten glass 126 is cooled as fast as possible to the cooling temperature T_{C} which is about 10° C. less than T_{M} and then held at that temperature or within a relatively small range of temperatures (e.g., 1500° C. to 1550° C.) for a predetermined resident time that is in a range of between about 10 minutes and 30 minutes. At step 206, the cooled molten glass 126 is then heated within the fining vessel 106 to a fining temperature T_{F}≧T_{M}. In one embodiment, the fining temperature T_{F} is in a range between about 1630° C. and 1720° C.

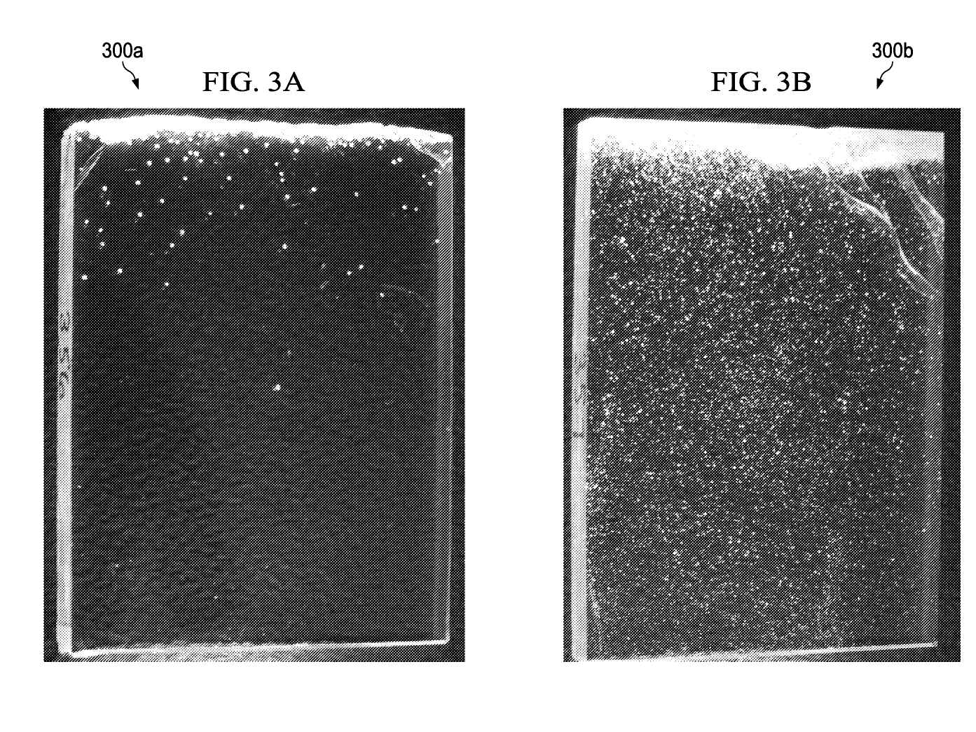

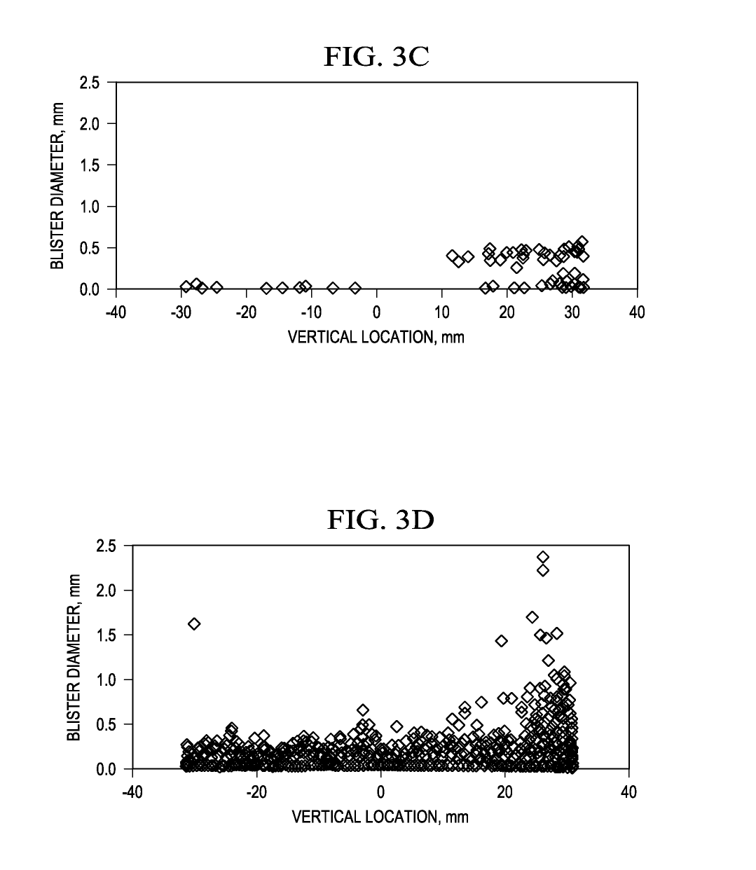

Referring to FIGS. 3A-3D, there are shown various photos and graphs which are the results of experiments conducted to test the method 200 in accordance with an embodiment of the present invention. In these experiments, a precious metal container was used to heat a batch material containing SnO₂ (fining agent) to 1600° C. (T_{M}) for 60 minutes to form molten glass 126 (Corning Eagle XG® glass) (step 202). Then, a refractory lid was placed on the opening of the precious metal container so that there was no free surface area for the molten glass 126. This particular set-up is where the precious metal container functioned as the cooling refractory tube 104 during which the molten glass 126 underwent the low temperature conditioning step and was held in one experiment at 1510° C. (T_{C}) for 10 minutes and in another experiment the molten glass 126 was held at 1600° C. (T_{C}) for 10 minutes (step 204). Thereafter, the refractory lid was raised to create a free surface area for the molten glass 126 so the precious metal container now functioned like the fining vessel 106 and in which the molten glass 126 for both experiments was heated to 1640° C. (T_{F}) for 30 minutes (step 206). Finally, the molten glass 126 for both experiments was quenched. FIGS. 3A and 3B are photos illustrating the effect of the conditioning temperature on the blisters in the quenched glass 300a and 300b was made when T_{C}=1510° C. and T_{C}=1600° C., respectively. FIGS. 3C and 3B are graphs illustrating the blister diameter (mm) vs. vertical location (mm) in 47 mm×63 mm×4 mm samples of quenched glass 300a and 300b that was made when T_{C}=1510° C. and T_{C}=1600° C., respectively. In conclusion, the conditioning step when T_{C}=1510° C. rather than 1600° C. resulted in a significant decrease in the blister count from 937 blisters/cm³ when T_{C}=1600° C. down to 6.5 blisters/cm³ when T₂=1510° C. Also, the quenched glass 300a that was held at T_{C}=1510° C. appeared to fine more efficiently during the fining step and had a smaller foamy layer on top when compared to the quenched glass 300b that was held as T_{C}=1600° C.

Referring to FIG. 4, there is shown a schematic view of an exemplary glass manufacturing system 400 in accordance with another embodiment of the present invention that uses a fusion process to make a glass sheet 422. The exemplary glass manufacturing system 400 includes a melting vessel 402 (e.g., melter 402, melting furnace 402), a melting vessel to finer connecting tube 404, a fining vessel 406, a new cooling refractory tube 408 (cooling refractory vessel 408), a mixing vessel 410 (e.g., stir chamber 410), a stir chamber to bowl connecting tube 412, a delivery vessel 414 (e.g. bowl 414), a downcomer 416, an inlet 418, and a forming vessel 420 (e.g. fusion pipe 420) which is used to form the glass sheet 422. Typically, the components 404, 406, 408, 410, 412, 414, 416 and 418 are made from platinum or platinum-containing metals such as platinum-rhodium, platinum-iridium and combinations thereof, but which may also comprise other refractory metals such as molybdenum, palladium, rhenium, tantalum, titanium, tungsten, or alloys thereof. The forming vessel 420 is typically made from a ceramic or glass-ceramic refractory material. In this embodiment, the cooling refractory tube 408 (which is shown as having optional cooling fins 409 extending therefrom) is positioned on an output of the fining vessel 406 which is different than the previous embodiment where the new cooling refractory tube 104 was positioned between the melting vessel 102 and the fining vessel 104 (compare FIGS. 1 and 4).

Glass raw materials are fed as shown by arrow 424 into the melting furnace 402 in accordance with a recipe specific to the desired glass composition. The raw feed materials may be fed in a batch mode or via a continuous method, and may include, but are not limited to, oxides of Si, Al, B, Mg, Ca, Zn, Sr, or Ba. Feed materials may also be cullet from previous melting operations. A non-toxic multivalent fining agent, such as SnO₂, may be included in the initial feed materials, or may be subsequently added to the molten glass 426. Alternatively, in the case of SnO₂, it may not be necessary to add the SnO₂ to the feed materials, as the electrode material in a melting furnace which incorporates electrically heated melting is often comprised of SnO₂. Thus, sufficient SnO₂ may be added to the molten glass 426 through the gradual disintegration of the electrodes. The feed materials may be heated by anyone of a variety of glass-making methods. For example, the feed materials may be initially heated by way of combustion burners located over the surface of the feed materials. Once a suitable temperature has been attained through the use of combustion burners such that the resistivity of the molten glass 426 is sufficiently lowered, an electric current may thereafter be passed through the body of the molten glass 426 by the electrodes to heat the molten glass 426 from within. In any case, the raw feed materials are heated within melting furnace 102 and melted to form the molten glass 426 at a melting temperature T_{M} (e.g., 1500° C.-1650° C.). The melting temperature T_{M} may vary depending upon the specific glass composition. For display glasses, and in particular hard glasses (i.e. glass having a high melting temperature), melting temperatures may be in excess of 1500 C, more preferably greater than about 1550° C.; and for some glasses at least about 1650° C.

In accordance with the present embodiment, once the raw feed materials have been melted at the melting temperature T_{M}, the glass melt 426 is heated within the fining vessel 406 to a fining temperature T_{F} which is typically greater than melting temperature T_{M}. For a glass which has been melted at a temperature T_{M} of about 1600° C., a typical ΔT_{FM} (=T_{F}−T_{M}) is about 20° C.-50° C. However, the value of ΔT_{FM} can depend upon factors like the glass composition. The molten glass 426 is preferably maintained at the fining temperature T_{F} for at least about 15 minutes. While the molten glass 426 is at the fining temperature T_{F}, the high temperature causes the fining agent to release oxygen in a fining step, sometimes referred to as reboil. This occurs according to a redox (reduction-oxidation) relationship. For example, a redox equation for a tin oxide fining agent is as follows:

$${SnO}_{2} ⇔ SnO + \frac{1}{2} {O}_{2} . \qquad ( 2 )$$

As the temperature of the molten glass 426 is increased, equation (1) is driven to the right, reducing the tin and releasing oxygen into the molten glass 426. A decrease in temperature drives the equation to the left, oxidizing the tin. A similar relationship exists for other multivalent fining agents. This redox relationship is also relevant to the first embodiment of the present invention.

In the fining step the high temperature release of oxygen by the fining agent becomes available to facilitate bubble growth through diffusion of the dissolved gases into the bubbles. The bubbles are buoyed to the free surface of the molten glass 426 in the fining vessel 406, where these bubbles burst and their gases are expelled from the molten glass 426.

Once the fining of the molten glass 426 has been completed, the molten glass 426 flows into the cooling refractory tube 408 and is cooled to a cooling temperature T_{C} which is less than the fining temperature (T_{F}), and in some examples the cooling temperature T_{C} can be less than the melting temperature T_{M}. Cooling the molten glass 426 in the cooling refractory tube 408 to the cooling temperature T_{C} that is less than the fining temperature T_{F} or less than the melting temperature T_{M} can drive equation (2) to the left, consuming oxygen in the molten glass 426 and decreasing bubble size. Eventually, bubbles may shrink to a size where they spontaneously collapse. Because, this embodiment (and the previous embodiment) of the present invention relies on bubble collapse as opposed to expelling the gas, a melt free surface is not necessary but could be present if desired within the cooling refractory tube 408. FIG. 5 is a graph that shows modeled data which indicates the time it takes a single bubble with a specific diameter to collapse when subjected to a variety of different temperatures after initially being subjected to an isothermal temperature of 1600° C. This data indicates that there is a reduction in the time to collapse bubbles with larger initial diameters when the temperature is decreased. However, the maximum benefit, that is, the fastest collapse time for these simulations, is achieved at 1530° C. as compared to 1500° C. and 1400° C. In fact, the simulations show that although bubbles collapse in decreasing the melt temperature to 1400° C., the process is very slow. In essence, the simulations show that although there is an advantage to having a cold step after an initial high-temperature step, the advantage is not as great when the temperature is reduced past some threshold say, below 1500° C. Thus, the preferred cooling temperature T_{C} is in a predetermined hold temperature range from about 1500° C. to about 1650° C., more preferably between 1510° C. and 1530° C. It should be appreciated that as the cooling temperature T_{C} approaches the fining temperature T_{F}, there is also reduced efficacy that is, the temperature can be too high.

After the molten glass 426 reaches the predetermined hold temperature range, the molten glass 426 is maintained within that predetermined temperature range for a period of at least about 30 minutes, preferably at least about 45 minutes, and more preferably at least about 60 minutes. Hold times longer than 60 minutes are possible, but must be weighed against the added process time. Holding the molten glass 426 at the cooling temperature T_{C} allows the multivalent fining agent to reabsorb oxygen contained in the molten glass 426, thereby causing a majority if not all of the bubbles that remain in the molten glass 426 after the fining step to collapse. Bubble collapse, particularly for small bubbles (e.g. bubbles having a diameter between about 0.005 mm and about 0.3 mm), is further facilitated by the bubble surface tension.

In other embodiments, optimal results may be obtained when the molten glass 426 is maintained at a substantially steady temperature within the above predetermined hold temperature range of about 1500° C. to about 1630° C. That is, at a selected temperature, and may vary by only a few degrees in either direction, e.g. T_{hold}±2° C. As used herein, T_{hold} represents a substantially constant temperature within the hold temperature range, whereas T_{C} is used to designate the hold temperature range. That is, T_{hold} is a subset of T_{C}. As shown above, when T_{C}=T_{hold}, the allowable temperature variation during the hold cycle is significantly condensed.

Once the molten glass 426 has experienced a low temperature hold T_{C}, the molten glass 426 is flowed to the mixing vessel 410 (e.g., stir chamber 410) for homogenization. Then, the molten glass 426 flows through the stir chamber to bowl connecting tube 412 to the delivery vessel 414 (e.g. bowl 414). The delivery vessel 414 delivers the molten glass 426 through the downcomer 416 and the inlet 418 into the forming vessel 420 (e.g., isopipe 420, fusion pipe 420) to form the glass sheet 422 per the fusion glass making process. It should be appreciated that components 410, 412, 414, 418 and 420 are not hot zones when compared to the cooling refractory tube 408. That is, there is a steady decline in process temperature in the direction of the flow of the molten glass 426 after the molten glass 426 passes through the cooling refractory tube 408 so as to avoid any thermal reboil or new bubble generation.

In the fusion glass making process, the molten glass 426 is flowed to the forming vessel 420 (also known as a fusion pipe, isopipe, forming wedge) where the molten glass 426 overflows the upper edges of the forming vessel 420. The molten glass 426 then flows down along converging forming surfaces on the forming vessel 420 and the separate flows join along the apex of the converging forming surfaces to form a glass sheet 422. Accordingly, the molten glass 426 which has been in contact with the converging forming surfaces forms the interior of the glass sheet 422, and the surface of the glass sheet 422 remains pristine. As indicated earlier, a more detailed description of a fusion glass forming method and apparatus may be found in U.S. Pat. Nos. 3,338,696 and 3,682,609. A person skilled in the art should readily appreciate that any type of glass manufacturing system that employs a fining vessel 406/fining step to make a glass sheet can also incorporate and use the new cooling refractory tube 408 in accordance with an embodiment of the present invention.

Referring to FIG. 6, there is a flowchart illustrating the basic steps of a method 600 for reducing gaseous inclusions in a glass in accordance with another embodiment of the present invention. Beginning at step 602, a batch material is heated within the melting vessel 402 to form molten glass 426 at a melting temperature T_{M}, where the molten glass 426 contains a multivalent oxide material (fining agent). In one embodiment, the melting temperature T_{M} is in a range between about 1500° and 1650° C. At step 604, the molten glass 426 is then heated within the fining vessel 406 to a fining temperature T_{F}≧T_{M}. In one embodiment, the fining temperature T_{F} is in a range between about 1630° C. and 1720° C. At step 606, the molten glass 426 is then cooled within the cooling refractory tube 408 from the fining temperature T_{F} to the cooling temperature T_{C}, where the molten glass 426 remains within the cooling refractory tube 408 for a predetermined resident time. In one embodiment, the cooling temperature T_{C} is in a range between about 1500° C. and 1630° C. or is chosen to coincide with a temperature at which the rate of absorption of oxygen from the molten glass 426 and from existing bubbles by the fining agent is a maximum. In one embodiment, the molten glass 426 resides within the cooling refractory tube 408 for a predetermined resident time that is at least about 1 hour. It should be noted that as with the hold temperature, the resident hold time is selected at least in part based on a tradeoff between eliminating more bubbles and extending the processing time. A nominal hold time of 1 hour has been found to represent an acceptable compromise, but a shorter or longer hold time may be implemented as a matter of choice.

In some embodiments, the molten glass 426 may be maintained within the cold hold temperature range by configuring the cooling refractory tube 408 (or cooling refractory vessel 408) to be sufficiently large to accommodate the volume of molten glass 426 expected to be received at a particular flow rate, and to account for the fluid exchange rate to ensure each discrete volume of molten glass 426 experiences the full hold time within the hold temperature range. Because the hold time may cause the molten glass 426 to cool below the hold temperature range, it is preferred that the cooling refractory tube 408 (be it the transport piping or a holding tank) which facilitates the low conditioning hold is heated. For example, the transport piping is typically a refractory metal, such as platinum or a platinum alloy (e.g. platinum-rhodium) that can be directly electrically heated by passing a current through the piping. Similarly, a hold vessel may be formed from a suitable metal and directly heated as above, the hold vessel may comprise separate electrodes (e.g. tin electrodes) and a current be passed through the molten glass 426 itself, or the hold vessel may be “fired” by an external source, such as one or more gas flames. Thus, the molten glass 426 may be heated during the hold time, but only so far is necessary to maintain a temperature of the glass melt within the hold temperature range and below the fining temperature (i.e. T_{F}).

Although several embodiments of the present invention have been illustrated in the accompanying Drawings and described in the foregoing Detailed Description, it should be understood that the invention is not limited to the embodiments disclosed, but is capable of numerous rearrangements, modifications and substitutions without departing from the spirit of the invention as set forth and defined by the following claims. For example, although a fusion downdraw technique has been used for illustrative purposes, the present invention is applicable to a wide range of glass-making methods (e.g. float glass processes). Similarly, the exemplary methods 200 and 600 disclosed herein are not limited to the manufacture of liquid crystal display glass, or necessarily to high melting temperature glasses. Likewise, a glass manufacturing system may implement a cooling refractory tube 104 located between a melting vessel and a fining vessel and another cooling refractory tube 408 located between a fining vessel and a mixing vessel. Moreover, the temperatures and ranges in the different temperature zones described supra are exemplary and can vary depending upon the desired composition of the final glass and the glass constituents of the batch or feed material.

1. A method for reducing gaseous inclusions in a glass, said method comprising the steps of:
(I) heating a batch material within a melting vessel to form molten glass at a melting temperature T_{M}, the molten glass comprising a multivalent oxide material;
(II) cooling the molten glass within a refractory metal tube to a cooling temperature T_{C} which is less than T_{M}, where the molten glass remains within the refractory metal tube for a predetermined resident time;
(III) heating the cooled molten glass within the refractory metal tube; and then
(IV) heating the cooled molten glass within a fining vessel to a fining temperature T_{F}≧T_{M}.

2. The method of claim 1, wherein step (II) includes cooling the molten glass until the T_{C} is about 10° C. less than the T_{M}.

3. The method of claim 1, wherein step (I) provides the T_{M} in a range between about 1500° C. and 1650° C., and step (IV) provides the T_{F} in a range between about 1630° C. and 1720° C.

4. The method of claim 1, wherein the molten glass remains in the refractory metal tube for the predetermined resident time which is in a range between about 10 minutes and 30 minutes.

5. The method of claim 1, wherein the refractory metal tube does not have a free surface area for the molten glass.

6. The method of claim 1, wherein steps (II)-(III) include controlling a temperature of the refractory metal tube.

7. The method of claim 1, wherein, during step (II), at least one cooling fin protruding from the refractory metal tube is used to facilitate cooling of the molten glass within the refractory metal tube to the T_{C}.

8. The method of claim 1, wherein step (II) further includes:
reducing a volume of the gaseous inclusions in the molten glass; and
migrating gas species out of the gaseous inclusions into the molten glass, where at least a portion of the gaseous inclusions collapse due to the reducing step and the migrating step.

9. The method of claim 1, wherein step (IV) includes releasing a fining gas from the multivalent oxide material into the molten glass, where the released fining gas increases a size of remaining gaseous inclusions in the molten glass so a larger portion of the remaining gaseous inclusion are removed from the molten glass than would have been if the cooling step was not performed during which at least a portion of the gaseous inclusions collapsed into the molten glass.

10. A method for reducing gaseous inclusions in a glass, said method comprising the steps of:
(I) heating a batch material within a melting vessel to form molten glass at a melting temperature T_{M}, the molten glass comprising a multivalent oxide material;
(II) heating the molten glass within a fining vessel to a fining temperature T_{F}≧T_{M}; and then
(III) cooling the molten glass within a refractory metal tube from T_{F} to a cooling temperature T_{C}<T_{M}, where T_{C} is in a range between about 1500° C. and 1630° C., where the molten glass remains within the refractory metal tube for a predetermined resident time of at least about 1 hour.

11. The method of claim 10, wherein the T_{C} does not vary substantially during the predetermined resident time that the molten glass is within the refractory metal tube.

12. The method of claim 10, wherein the cooling step further includes:
reducing a volume of the gaseous inclusions in the molten glass; and
migrating gas species out of the gaseous inclusions into the molten glass, where at least a portion of the gaseous inclusions collapse due to the reducing step and the migrating step.

13. The method of claim 1, wherein step (III) is used to maintain T_{C} within a desired hold temperature range during the predetermined resident time.

14. The method of claim 1, wherein step (III) is used to maintain T_{C} within a desired hold temperature range of about 10° C. less than the T_{M} during the predetermined resident time.

15. The method of claim 1, wherein, after step (II), step (III) is used to raise the temperature of the molten glass within the refractory metal tube before passing the molten glass into the fining vessel.

16. The method of claim 1, wherein, during step (III), a heating mechanism attached to the refractory metal tube is used to facilitate heating of the cooled molten glass within the refractory metal tube.

17. The method of claim 10, further comprising the step of heating the cooled molten glass within the refractory metal tube.

18. The method of claim 17, wherein the step of heating the cooled molten glass within the refractory metal tube is used to maintain T_{C} within a desired hold temperature range during the predetermined resident time.

19. The method of claim 17, wherein, a heating mechanism attached to the refractory metal tube is used to facilitate heating of the cooled molten glass within the refractory tube.

20. The method of claim 10, wherein, during step (III), at least one cooling fin protruding from the refractory metal tube is used to facilitate cooling of the molten glass within the refractory metal tube to the T_{C}.
